(19) United States
(12) Patent Application Publication
(10) Pub. No.: US 2024/0106772 A1
(43) Pub. Date: Mar. 28, 2024

(54) REAL TIME CHAT SYSTEM AND APPARATUS, DEVICE, AND STORAGE MEDIUM

(71) Applicant: BEIJING BYTEDANCE NETWORK TECHNOLOGY CO., LTD., Beijing (CN)

(72) Inventors: Di FU, Beijing (CN); Xiaozhou CAO, Beijing (CN)

(21) Appl. No.: 18/254,426

(22) PCT Filed: Nov. 22, 2021
(86) PCT No.: PCT/CN2021/131995

§ 371 Date: May 25, 2023

(30) Foreign Application Priority Data
Nov. 25, 2020 (CN) 202011335239.6

(51) Int. Cl. H04L 51/043; H04L 65/1093

(52) U.S. Cl. CPC H04L 51/043; H04L 65/1093

(57) ABSTRACT

A co-hosting system, method, apparatus and device, and a storage medium are provided. The co-hosting method includes: replying, by a co-hosting service server side, to a co-hosting inviter side with a response message carrying a virtual room identifier, in response to a co-hosting request received from the co-hosting inviter side, where the response message indicates a successful reception of the co-hosting request, and the virtual room identifier is used to enable the co-hosting inviter side to enter a virtual room; and forwarding, by the co-hosting service server side, a co-hosting acceptance message to the co-hosting inviter side, in response to the co-hosting acceptance message for the co-hosting request received from a co-hosting invitee side.

### CROSS-REFERENCE TO RELATED APPLICATIONS

The present disclosure is a national stage of International Application No. PCT/CN2021/131995, filed on Nov. 22, 2021, which claims priority to Chinese Patent Application No. 202011335239.6, titled “REAL-TIME CHAT SYSTEM AND APPARATUS, DEVICE, AND STORAGE MEDIUM”, filed with the China National Intellectual Property Administration on Nov. 25, 2020, both of which are incorporated herein by reference in their entireties.

### FIELD

The present disclosure relates to the field of data processing, and in particular, to a co-hosting system, method and apparatus, a device, and a storage medium.

### BACKGROUND

In the online live function, co-hosting has become a common form of live. Generally, co-hosting refers to the real-time communication and interaction between anchors or between an anchor and an audience in a manner which is similar to a video call.

Co-hosting efficiency is one of the significant factors that affect the experience of users participating in co-hosting, especially for the users of the co-hosting invitee side. After actively clicking to accept a co-hosting invitation, the user of the co-hosting invitee side desires to access the communication interactive interface for co-hosting participants as soon as possible.

### SUMMARY

In order to solve all or at least part of the above technical problems, a co-hosting system, method and apparatus, a device, and a storage medium are provided according to the present disclosure.

In a first aspect, a co-hosting system is provided according to the present disclosure, the system includes: a co-hosting service server side, a co-hosting inviter side, and a co-hosting invitee side.

The co-hosting service server side is configured to reply to the co-hosting inviter side with a response message carrying a virtual room identifier, in response to a co-hosting request received from the co-hosting inviter side, where the response message is used to indicate a successful reception of the co-hosting request.

The co-hosting inviter side is configured to acquire the virtual room identifier from the response message in response to a reception of the response message; enter a virtual room corresponding to the virtual room identifier; and push an audio and video streaming to a real-time collaboration server side, in response to a co-hosting acceptance message for the co-hosting request received from the co-hosting invitee side.

The co-hosting invitee side is configured to pull the audio and video streaming from the real-time collaboration server side, in response to a co-hosting acceptance operation.

In an optional implementation, the co-hosting service server side is further configured to send a co-hosting invitation message carrying the virtual room identifier to the co-hosting invitee side, after receiving the co-hosting request, where the co-hosting invitation message is used to request the co-hosting invitee side to accept the co-hosting invitation.

The co-hosting invitee side is further configured to acquire the virtual room identifier from the co-hosting invitation message after receiving the co-hosting invitation message, and enter the virtual room corresponding to the virtual room identifier.

In an optional implementation, the co-hosting service server side is further configured to determine whether versions of the co-hosting inviter side and the co-hosting invitee side corresponding to the co-hosting request meet a preset condition, after receiving the co-hosting request; and replying to the co-hosting inviter side with a response message carrying a virtual room identifier, in response to a determination that the versions of the co-hosting inviter side and the co-hosting invitee side corresponding to the co-hosting request meet the preset condition.

In an optional implementation, the co-hosting service server side is further configured to update both co-hosting states of the co-hosting inviter side and the co-hosting invitee side to be in a connected state, in response to the co-hosting acceptance message for the co-hosting request received from the co-hosting invitee side; start timing; and update the co-hosting state of the co-hosting inviter side or the co-hosting state of the co-hosting invitee side to be in a disconnected state, in a case that no co-hosting notification message is received from the co-hosting inviter side or the co-hosting invitee side within a preset time period.

In an optional implementation, the co-hosting inviter side is in an online live state.

The co-hosting inviter side is further configured to stop pushing online live streaming to an online live server side and start pushing the audio and video streaming to the real-time collaboration server side, in response to the co-hosting acceptance message for the co-hosting request received from the co-hosting invitee side.

In a second aspect, a co-hosting method is provided according to the present disclosure, the method includes:

replying, by a co-hosting service server side, to a co-hosting inviter side with a response message carrying a virtual room identifier, in response to a co-hosting request received from the co-hosting inviter side, where the response message is used to indicate a successful reception of the co-hosting request, and the virtual room identifier is used to enable the co-hosting inviter side to enter the virtual room; and

forwarding, by the co-hosting service server side, a co-hosting acceptance message to the co-hosting inviter side, in response to the co-hosting acceptance message for the co-hosting request received from a co-hosting invitee side.

In an optional implementation, before the forwarding, by the co-hosting service server side, a co-hosting acceptance message to the co-hosting inviter side, in response to the co-hosting acceptance message for the co-hosting request received from a co-hosting invitee side, the method further includes:
sending, by the co-hosting service server side, a co-hosting invitation message carrying the virtual room identifier to the co-hosting invitee side, after receiving the co-hosting request, where the co-hosting invitation message is used to request the co-hosting invitee side to accept the co-hosting invitation, and the virtual room identifier is used to enable the co-hosting invitee side to enter the virtual room.

In an optional implementation, before the replying to a co-hosting inviter side with a response message carrying a virtual room identifier, the method further includes:
determining, by the co-hosting service server side, whether versions of the co-hosting inviter side and the co-hosting invitee side corresponding to the co-hosting request meet a preset condition.

Correspondingly, the replying to a co-hosting inviter side with a response message carrying a virtual room identifier includes:
replying to the co-hosting inviter side with the response message carrying the virtual room identifier, in response to a determination that versions of the co-hosting inviter side and the co-hosting invitee side corresponding to the co-hosting request meet the preset condition.

In an optional implementation, the method further includes:
updating, by the co-hosting service server side, both co-hosting states of the co-hosting inviter side and the co-hosting invitee side to be in a connected state, and starting timing, in response to the co-hosting acceptance message for the co-hosting request received from the co-hosting invitee side; and
updating both the co-hosting states of the co-hosting inviter side and the co-hosting invitee side to be in a disconnected state, in a case that no co-hosting notification message is received from the co-hosting inviter side and the co-hosting invitee side within a preset time period.

In a third aspect, a co-hosting method is provided according to the present disclosure, the method includes:
acquiring, by a co-hosting inviter side, a virtual room identifier from a response message, in response to a reception of the response message for a co-hosting request, after sending the co-hosting request to the co-hosting service server side; and entering a virtual room corresponding to the virtual room identifier; and
pushing an audio and video streaming to a real-time collaboration server side, in response to a co-hosting acceptance message for the co-hosting request received from a co-hosting invitee side, wherein the audio and video streaming is used to be pulled by the co-hosting invitee side.

In an optional implementation, the co-hosting inviter side is in an online live state; before pushing the audio and video streaming to the real-time collaboration server side, the method further includes:
stop pushing online live streaming to an online live server side, in response to the co-hosting acceptance message for the co-hosting request received from the co-hosting invitee side.

In a fourth aspect, a co-hosting method is provided according to the present disclosure, the method includes:
acquiring, by a co-hosting invitee side, a virtual room identifier from a co-hosting invitation message after receiving the co-hosting invitation message, and entering into an virtual room corresponding to the virtual room identifier, wherein the co-hosting invitation message is used to request the co-hosting invitee side to accept a co-hosting invitation; and
pulling, by the co-hosting invitee side, an audio and video streaming from a real-time collaboration server side, in response to a reception of the co-hosting invitation corresponding to the co-hosting invitation message.

In a fifth aspect, a co-hosting apparatus is provided according to the present disclosure. The apparatus includes: a replying module and a forwarding module.

The replying module is configured to reply to a co-hosting inviter terminal with a response message carrying a virtual room identifier, in response to a co-hosting request received from the co-hosting inviter side, where the response message is used to indicate a successful reception of the co-hosting request, and the virtual room identifier is used to enable the co-hosting inviter side to enter the virtual room.

The forwarding module is configured to forward a co-hosting acceptance message to the co-hosting inviter side, in response to the co-hosting acceptance message for the co-hosting request received from a co-hosting invitee side.

In a sixth aspect, a co-hosting apparatus is provided according to the present disclosure. The apparatus includes: a first acquisition module, a first entering module and a pushing module.

The first acquisition module is configured to acquire a virtual room identifier from a response message, in response to a reception of the response message for a co-hosting request, after sending the co-hosting request to a co-hosting service server side.

The first entering module is configured to enter a virtual room corresponding to the virtual room identifier.

The pushing module is configured to push an audio and video streaming to a real-time collaboration server side, in response to a co-hosting acceptance message for the co-hosting request received from a co-hosting invitee side.

In a seventh aspect, a co-hosting apparatus is provided according to the present disclosure. The apparatus includes: a second acquisition module, a second entering module and a pulling module.

The second acquisition module is configured to acquire a virtual room identifier from a co-hosting invitation message after receiving the co-hosting invitation message, where the co-hosting invitation message is used to request a co-hosting invitee side to accept a co-hosting invitation.

The second entering module is configured to enter a virtual room corresponding to the virtual room identifier.

The pulling module is configured to pull an audio and video streaming from a real-time collaboration server side, in response to a reception of the co-hosting invitation corresponding to the co-hosting invitation message.

In an eighth aspect, a computer readable storage medium storing instructions is provided according to the present disclosure. The instructions, when executed by a computer device, cause the computer device to implement the above co-hosting method.

In a ninth aspect, a device is provided according to the present disclosure. The device including: a memory; a processor; and a computer program stored in the memory, the computer program, when executed by the processor, causes the processor to implement the above co-hosting method.

### BRIEF DESCRIPTION OF THE DRAWINGS

The drawings herein are incorporated into the specification and constitute a part of the specification, which show embodiments which comply with the present disclosure. The drawings and the specification are used as a whole to explain the principle of the present disclosure.

In order to more clearly illustrate the embodiments of the present disclosure or the technical solutions in the conventional art, the drawings used in the description of the embodiments or the conventional art are briefly introduced below. It is apparent that, for those skilled in the art, other drawings can be obtained according to the provided drawings without any creative effort.

FIG. 1 illustrates a schematic diagram of data interaction in a co-hosting mode during an online live according to the conventional technology;

FIG. 2 illustrates a signaling interaction diagram in which an anchor A invites an anchor B for co-hosting according to an embodiment of the present disclosure;

FIG. 3 illustrates a schematic structural diagram of a co-hosting system according to an embodiment of the present disclosure;

FIG. 4 illustrates a flowchart of a co-hosting method according to an embodiment of the present disclosure;

FIG. 5 illustrates a flowchart of a co-hosting method according to another embodiment of the present disclosure;

FIG. 6 illustrates a flowchart of a co-hosting method according to another embodiment of the present disclosure;

FIG. 7 illustrates a schematic structural diagram of a co-hosting apparatus according to an embodiment of the present disclosure;

FIG. 8 illustrates a schematic structural diagram of a co-hosting apparatus according to another embodiment of the present disclosure;

FIG. 9 illustrates a schematic structural diagram of a co-hosting apparatus according to another embodiment of the present disclosure; and

FIG. 10 illustrates a schematic structural diagram of a co-hosting device according to an embodiment of the present disclosure.

### DETAILED DESCRIPTION OF EMBODIMENTS

In order to understand the above purposes, features, and advantage of the present disclosure more clearly, the technical solutions according to the present disclosure will be further described. It should be noted that the embodiments of the present disclosure and the features in the embodiments may be combined with each other if there is no conflict.

In the following description, numerous specific details are set forth in order to provide thorough understanding of the present disclosure. However, the present disclosure may also be implemented in other ways different from those described here. Obviously, the embodiments in the specification are only a part of the embodiments of the present disclosure, rather than all the embodiments.

In the process of online live, real-time communication and interaction are often realized between anchors or between an anchor and an audience in a way similar to a video call, also known as co-hosting.

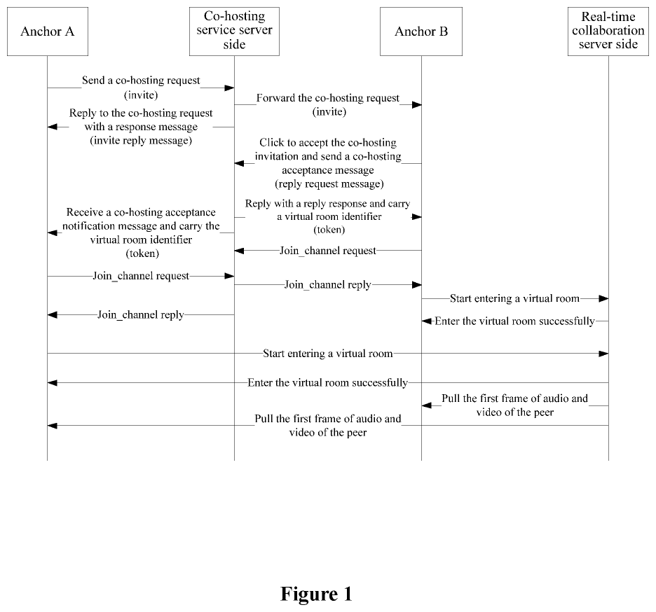

At present, in the co-hosting mode of online live, the user at the co-hosting invitee side needs to wait for a long time after actively clicking to accept a co-hosting invitation, which affects the co-hosting experience of the user. Taking co-hosting between anchors as an example, FIG. 1 illustrates a schematic diagram of data interaction in a co-hosting mode during online live according to the conventional technology.

As shown in FIG. 1, an anchor A sends a co-hosting invitation to an anchor B. After receiving the co-hosting acceptance message from the anchor B, the co-hosting service server side sends a co-hosting acceptance notification message to the anchor A. A virtual room identifier of the virtual room is carried in the co-hosting acceptance notification message, and is used to enter the virtual room of this co-hosting. In other words, the anchor A can only enter the virtual room corresponding to the virtual room identifier at this moment. However, for the anchor B, the anchor B receives a response message after clicking to accept co-hosting invitation. At this time, the anchor B can enter the virtual room; and push audio and video streaming to the real-time collaboration (Real-Time Communications, RTC) server side or pull audio and video streaming from the RTC server side. Obviously, the anchor B enters the virtual room earlier than the anchor A. As a result, the anchor B needs to wait for anchor A to enter the virtual room before pulling the audio and video streaming of the anchor A, to realize the co-hosting of both sides.

From experience perspective of the anchor B, after actively clicking to accept the co-hosting invitation, the anchor B has to wait for the anchor A to enter the virtual room before pulling the first frame of the audio and video of the anchor A to realize the co-hosting of both sides. It is apparent that such waiting time will affect the experience of the anchor B. In view of this, the inventors provide an optimization solution for co-hosting. The above co-hosting method has a low efficiency, which causes the users of the co-hosting invitee to wait too long after accepting the co-hosting invitation, thereby affecting the co-hosting experience of the user. Hence, one of the ways to improve the co-hosting experience of the users is to minimize the waiting time of users of the co-hosting invitee side after co-hosting invitation is accepted.

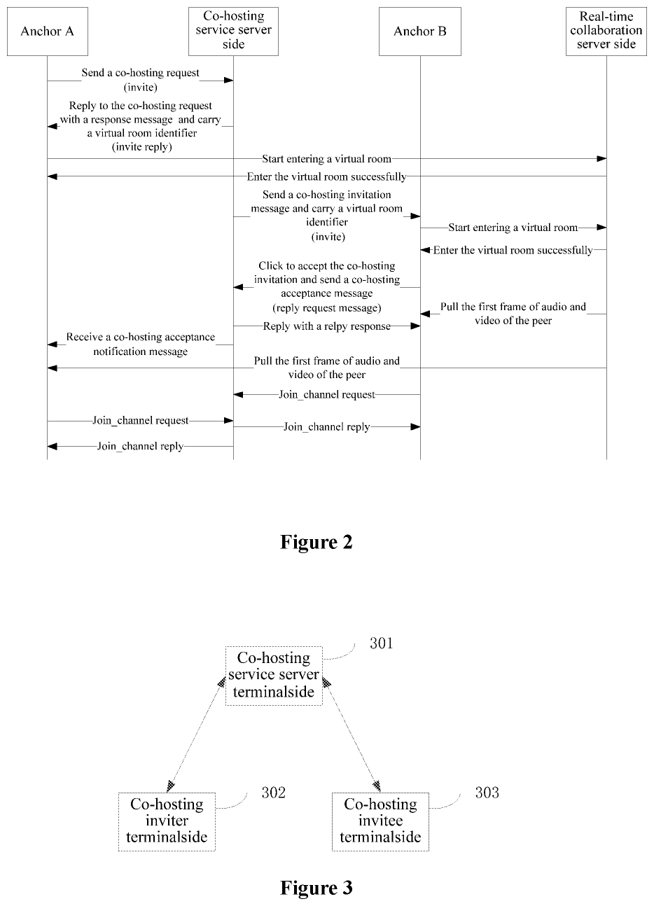

As shown in FIG. 2, FIG. 2 illustrates a signaling interaction diagram in which an anchor A invites an anchor B for co-hosting according to an embodiment of the present disclosure. When the co-hosting service server side receives a co-hosting request of the anchor A, a response message carrying a virtual room identifier is returned to the anchor A, such that the anchor A is able to enter the virtual room in advance. When the anchor B accepts the co-hosting invitation of the anchor A, the anchor A has already entered the virtual room in advance. Thus, the anchor B can pull the audio and video streaming of the anchor A without waiting for anchor A to enter the virtual room, which improves co-hosting efficiency and the co-hosting experience of the anchor B.

Based on this, a co-hosting system is provided according to an embodiment of the present disclosure. Referring to FIG. 3, FIG. 3 illustrates a schematic structural diagram of a co-hosting system according to an embodiment of the present disclosure. The co-hosting system includes: a co-hosting service server side 301, a co-hosting inviter side 302, and a co-hosting invitee side 303.

The co-hosting service server side 301 is configured to reply to the co-hosting inviter side with a response message carrying a virtual room identifier in response to a co-hosting request received from the co-hosting inviter side. The response message is used to indicate a successful reception of the co-hosting request.

In an embodiment of the present disclosure, the co-hosting request is used to request the co-hosting invitee side to accept the co-hosting invitation from the co-hosting inviter side.

In practical applications, the co-hosting inviter side sends a co-hosting request to the co-hosting service server to request the co-hosting invitee side to accept co-hosting invitation. After receiving the co-hosting request, the co-hosting service server replies a response message to the co-hosting inviter side to inform the co-hosting inviter side that the co-hosting request has been successfully received.

In order to enable the co-hosting inviter side to enter the virtual room in advance rather than waiting for the invitation to be accepted by the co-hosting invitee side, the co-hosting service server side replies to the co-hosting inviter side with a response message for the co-hosting request, and the response message carries the virtual room identifier for entering the virtual room in the embodiment of the present disclosure.

In an optional implementation, the virtual room identifier may include a virtual room ID and virtual room verification information, and the corresponding virtual room may be entered based on the virtual room identifier.

The co-hosting inviter side 302 is configured to acquire the virtual room identifier from the response message in response to a reception of the response message; enter a virtual room corresponding to the virtual room identifier; and push an audio and video streaming to the real-time collaboration server side in response to a co-hosting acceptance message for the co-hosting request received from the co-hosting invitee side.

In an embodiment of the present disclosure, after the co-hosting inviter side sends a co-hosting request to the co-hosting service server side, the co-hosting service server side sends a response message for the co-hosting request to inform that the co-hosting request is successfully received. When the co-hosting inviter side receives the response message, the carried virtual room identifier is acquired from the response message, and then the virtual room corresponding to the virtual room identifier is entered based on the virtual room identifier.

In order to improve the co-hosting efficiency, the co-hosting inviter side can enter the virtual room corresponding to the co-hosting in advance after acquiring the virtual room identifier from the response message, so as to save the time of entering the room subsequently and improve the co-hosting efficiency.

In an embodiment of the present disclosure, the co-hosting inviter side may be in an online live state, or in a non-online live state, such as an online but not live state.

In an optional implementation, in the case that the co-hosting inviter side is in the online live state, upon receiving a co-hosting acceptance message for the co-hosting request from the co-hosting invitee side, the co-hosting inviter side stops pushing online live streaming to the online live server side, and starts pushing audio and video streaming to the real-time collaboration server side. In other words, when receiving the co-hosting acceptance message from the co-hosting invitee side, the co-hosting inviter side starts to switch from the online live state to a co-hosting state.

In practical applications, both the co-hosting service server side 301 and the online live server side can be deployed on the live server, that is, the live server may be used to realize functions of the co-hosting service server side 301 and the online live server side. The co-hosting service server side 301 and the online live server side may also be deployed on independent servers, that is, different servers are used to realize the function of the co-hosting service server side 301 and the function of the online live server side respectively. The deployment manner of the co-hosting service server side 301 and the online live server side are not limited in the embodiment of the present disclosure.

In the embodiment of the present disclosure, after receiving the co-hosting request, the co-hosting service server side forwards the co-hosting request to the co-hosting invitee side corresponding to the co-hosting request. The co-hosting invitee side can select whether to accept the co-hosting request after receiving the co-hosting request.

In the case that the co-hosting invitee side accepts the co-hosting invitation, the co-hosting invitee side sends a co-hosting acceptance message for the co-hosting request to the co-hosting service server side, to inform the co-hosting service server side that the co-hosting invitation is accepted. After receiving the co-hosting acceptance message from the co-hosting invitee side, the co-hosting service server side forwards the co-hosting acceptance message to the co-hosting inviter side, to inform the co-hosting inviter side that the co-hosting invitee side has accepted the co-hosting invitation.

In this case, if the co-hosting inviter side is in the online live state, the current online live streaming is disconnected and the audio and video streaming is started to push to the real-time collaboration RTC server, in response to determining that the co-hosting invitee side has accepted the co-hosting invitation.

In addition, for the co-hosting inviter side, the co-hosting inviter side enters the virtual room of the co-hosting in advance. Thus, after receiving the co-hosting acceptance message from the peer, the co-hosting inviter side directly starts pushing the audio and video streaming to the RTC server, and pulls the audio and video streaming from the peer, so as to achieve the co-hosting between the two sides. Since the co-hosting inviter side enters the virtual room in advance, it can reduce the consumption time from the co-hosting inviter side receiving the co-hosting acceptance message from the peer to the co-hosting inviter side pulling the first frame of the audio and video streaming from the peer, thereby improving co-hosting efficiency.

The co-hosting invitee side 303 is configured to pull the audio and video streaming from the real-time collaboration server in response to a co-hosting acceptance operation.

In an embodiment of the present disclosure, after receiving the co-hosting request forwarded by the co-hosting service server side, in the case that the co-hosting acceptance operation is triggered, the co-hosting invitee side can enter the virtual room of the co-hosting, push the audio and video streaming to the RTC server, and pull the audio and video streaming of the peer from the RTC server, to realize the co-hosting. In the case that a co-hosting rejection operation is triggered, a co-hosting rejection message is replied to the co-hosting service server side, to inform the co-hosting service server side that the co-hosting invitation is not accepted.

The co-hosting invitee side 303 may be in an online live state, or in a non-online live state, such as an online but not live state.

In an embodiment of the present disclosure, after the co-hosting invitee side triggers the co-hosting acceptance operation, since the co-hosting inviter side enters the virtual room in advance, the co-hosting invitee side no need to wait for the co-hosting inviter side to enter the virtual room, which saves the consumption time from the co-hosting invitee side triggering co-hosting acceptance operation to the co-hosting invitee side pulling the first frame of audio and video of the peer, so as to improve the co-hosting efficiency and also improve the experience of the user at the co-hosting invitee side.

In practical applications, the co-hosting invitee side pushes audio and video streaming to the RTC server and pulls the audio and video streaming of the peer. The co-hosting inviter side pulls the audio and video streaming of the co-hosting invitee side after determining that the peer pushes the audio and video streaming. When both sides pull the audio and video streaming from the peers, the co-hosting between the two sides is realized.

In an optional implementation, if the co-hosting invitee side is in the online live state, after the co-hosting invitee side triggers the co-hosting acceptance operation, the co-hosting invitee side first stops pushing the online live streaming to the online live server, and starts pushing audio and video streaming to the real-time collaboration server. In other words, after triggering the co-hosting acceptance operation, the co-hosting invitee side starts to switch from the online live state to the co-hosting state.

In the co-hosting system provided by the embodiments of the present disclosure, when receiving the co-hosting request, the co-hosting service server side replies to the co-hosting inviter side with a response message carrying the virtual room identifier, so that the co-hosting inviter side can enter the virtual room in advance. When receiving a co-hosting acceptance message from co-hosting invitee side, the co-hosting inviter side pushes the audio and video streaming to the real-time collaboration server side. Correspondingly, when receiving the co-hosting acceptance operation, the co-hosting invitee side directly pulls the audio and video streaming from the real-time collaboration server side, implementing co-hosting on both sides.

The co-hosting inviter side has already entered the virtual room in advance when co-hosting invitee side receives the co-hosting acceptance operation. Thus, the co-hosting invitee side does not need to wait for the peer to enter the virtual room, which directly pulls the first frame of the audio and video streaming of the peer after entering the virtual room, which improves co-hosting efficiency, as well as the co-hosting experience of the users.

As shown in FIG. 1, after the anchor B (i.e., co-hosting invitee side) triggers an acceptance of co-hosting invitation, a co-hosting acceptance message is sent to the co-hosting service server side. The co-hosting service server side replies to the anchor B with a response message for the co-hosting acceptance message after receiving the co-hosting acceptance message. The response message is used to inform the co-hosting service server side that the message is received successfully. The response message carries the virtual room identifier. Only when receiving the response message, the anchor B can enter the virtual room based on the virtual room identifier in the response message. Apparently, after the anchor B accepts the co-hosting invitation, the anchor B will spend time on entering the virtual room. Based on this, the inventors provide a further optimization solution for co-hosting.

In an embodiment of the present disclosure, the co-hosting invitee side may enter the virtual room in advance, to save the waiting time of the co-hosting invitee side after triggering the acceptance of the co-hosting invitation, and improve the co-hosting efficiency. For this reason, in an embodiment of the present disclosure, after receiving the co-hosting request, the co-hosting service server side sends a co-hosting invitation message to co-hosting invitee side. The co-hosting invitation message carries a virtual room identifier. In this way, when the co-hosting invitee side receives the co-hosting invitation message, it can enter the virtual room in advance based on the virtual room identifier carried in the co-hosting invitation message, which saves the waiting time of the co-hosting invitee side after triggering the acceptance of the co-hosting invitation and improves the co-hosting experience of co-hosting invitee side.

In an embodiment, the co-hosting service server side 301 is further configured to send a co-hosting invitation message carrying the virtual room identifier to the co-hosting invitee side, after receiving the co-hosting request. The co-hosting invitation message is used to request the co-hosting invitee side to accept a co-hosting invitation.

In an embodiment of the present disclosure, the co-hosting invitation message is obtained, by the co-hosting service server side adding the virtual room identifier to the co-hosting request after receiving the co-hosting request from the co-hosting inviter side, which is used to indicate that the co-hosting inviter side is requested to accept the co-hosting invitation.

The co-hosting invitee side 303 is further configured to acquire the virtual room identifier from the co-hosting invitation message after receiving the co-hosting invitation message, and enter the virtual room corresponding to the virtual room identifier.

As shown in FIG. 2, when the co-hosting service server side sends a co-hosting invitation message to the anchor B, the co-hosting invitation message carries the virtual room identifier. In this case, the anchor B can enter the co-hosting virtual room in advance based on the virtual room identifier. In this way, there is no need to wait for entering the room until the anchor B triggers the co-hosting acceptance operation, which improves the co-hosting experience of the anchor B.

In addition, since the version of the client affects a success rate of co-hosting, a lower version of the client may usually cause co-hosting failure. Therefore, in an embodiment of the present disclosure, in order to improve the success rate of co-hosting, after receiving the co-hosting request from the co-hosting inviter side, the co-hosting service server side first determines whether versions of the client of the co-hosting inviter side and the co-hosting invitee side corresponding to the co-hosting request meet a preset condition.

In an embodiment, the co-hosting service server side 301 is further configured to determine whether versions of the co-hosting inviter side and the co-hosting invitee side corresponding to the co-hosting request meet a preset condition, after receiving the co-hosting request. In response to a determination of the versions of the co-hosting inviter side and the co-hosting invitee side corresponding to the co-hosting request meeting the preset condition, the step of replying to the co-hosting inviter side with the response message carrying the virtual room identifier is performed.

In an optional implementation, after receiving co-hosting request, the co-hosting service server side can acquire the client versions of co-hosting inviter side and co-hosting invitee side respectively. If it is determined that the client versions of both sides meet the preset condition, it with the response message carrying the virtual room identifier is replied to the co-hosting inviter side, to improve the success rate of the co-hosting. For example, the preset condition may be the client having the highest version.

In addition, the co-hosting service server side stores the co-hosting states of the co-hosting inviter side and the co-hosting invitee side, which may be used for various other services. For example, in the PK scenario, it is required to call the StartBattle service side after one of the PK sides pulling the audio and video streaming from the other side. Before starting the PK, the StartBattle service side needs to verify the co-hosting state of both PK sides. The PK is only started when both PK sides are in the connected state.

To this end, the co-hosting service server side needs to acquire the co-hosting states of co-hosting inviter side and co-hosting invitee side. In the co-hosting solution in FIG. 1, before entering the virtual room, the co-hosting inviter side and co-hosting invitee side need to send co-hosting notification messages (i.e., join channel requests) to the co-hosting service server side to inform the co-hosting service server side that they are ready to enter the virtual room for co-hosting. After receiving the co-hosting notification message, the co-hosting service server side updates the co-hosting state of the client corresponding to the co-hosting notification message to be in the connected state, so as to ensure the successful execution of the above PK service.

In an embodiment of the present disclosure, in order to improve co-hosting efficiency, the process of the co-hosting inviter side and co-hosting invitee side sending co-hosting notification messages to the co-hosting service server side, and the process of the co-hosting inviter side and co-hosting invitee side entering the co-hosting virtual room, are processed in parallel. In other words, in the embodiment of the present disclosure, the co-hosting inviter side and the co-hosting invitee side can enter the virtual room, without sending co-hosting notification messages to the co-hosting service server side before entering the virtual room.

Correspondingly, when receiving the co-hosting acceptance message for the co-hosting request from the co-hosting invitee side, the co-hosting service server side updates the state of the co-hosting invitee side and the co-hosting inviter side to be in the connected state, indicating that the two sides are already co-hosted at this time. The state updating process may not affect functions such as verification of other services in the co-hosting service server side. At the same time, the co-hosting service server side starts timing. If no co-hosting notification message is received from the co-hosting inviter side or the co-hosting invitee side within a preset time period, the co-hosting service server side updates the co-hosting state of the corresponding client to be in the disconnected state. If the co-hosting notification message is received, the co-hosting state of the client that sends the co-hosting notification message remains in the connected state.

It can be seen that the co-hosting invitee side and the co-hosting inviter side only need to send the co-hosting notification messages to the co-hosting service server side within the preset time period from starting the timing. The timing of sending the co-hosting notification message does not affect the co-hosting invitee side and co-hosting inviter side to enter the virtual room, thereby improving the co-hosting efficiency.

In an embodiment, in the above co-hosting system, the co-hosting service server side 301 is further configured to update co-hosting states of the co-hosting inviter side and the co-hosting invitee side to be in the connected state in response to the co-hosting acceptance message for the co-hosting request received from the co-hosting invitee side; start timing; and update the co-hosting states of the co-hosting inviter side and the co-hosting invitee side to be in the disconnected state, in the case that no co-hosting notification message from the co-hosting inviter side and the co-hosting invitee side is received within the preset time period.

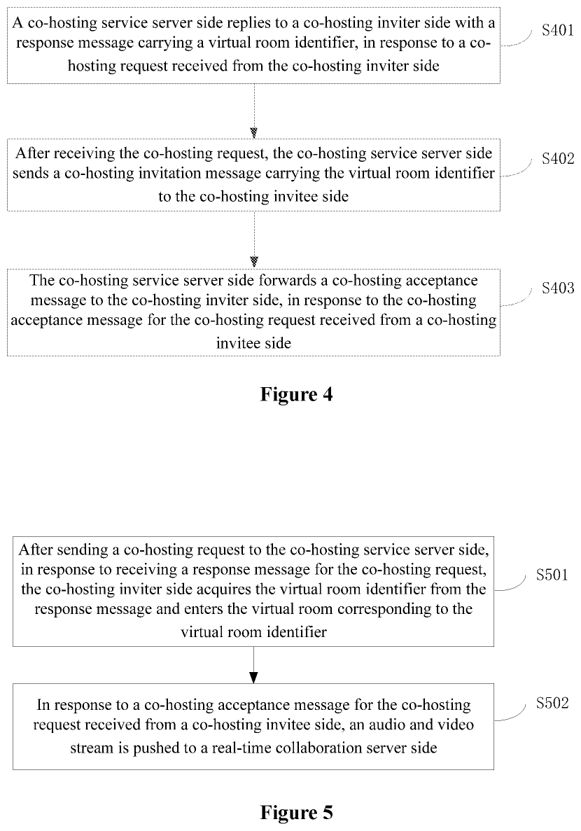

Based on the above system embodiment, a co-hosting method is further provided according to the present disclosure. Referring to FIG. 4, FIG. 4 illustrates a flowchart of a co-hosting method according to an embodiment of the present disclosure. The method includes steps S401 to S403.

In S401, a co-hosting service server side replies to a co-hosting inviter side with a response message carrying a virtual room identifier, in response to a co-hosting request received from the co-hosting inviter side.

The response message is used to indicate a successful reception of the co-hosting request, where the virtual room identifier is used to enable the co-hosting inviter side to enter the virtual room.

In an embodiment of the present disclosure, the co-hosting service server side carries the virtual room identifier in the response message for the co-hosting request, so that the co-hosting inviter side can enter the virtual room in advance based on the virtual room identifier, which saves the consumption time from the co-hosting inviter side receiving the co-hosting acceptance message from the peer to the co-hosting inviter side pulling the first frame of the audio and video streaming from the peer, thereby improving the co-hosting efficiency.

In S402, after receiving the co-hosting request, the co-hosting service server side sends a co-hosting invitation message carrying the virtual room identifier to the co-hosting invitee side.

The co-hosting invitation message is used to request the co-hosting invitee side to accept the co-hosting invitation. The virtual room identifier is used to enable the co-hosting invitee side to enter the virtual room.

In an embodiment of the present disclosure, after receiving the co-hosting request, the co-hosting service server side sends the co-hosting invitation message to the co-hosting invitee side, so as to request the co-hosting invitee side to accept the co-hosting invitation.

In order to enable the co-hosting invitee side to enter the co-hosting virtual room in advance, in the embodiment of the present disclosure, the virtual room identifier is carried in co-hosting invitation message, so that the co-hosting invitee side can enter the virtual room in advance based on the virtual room identifier. In this way, the consumption time from the co-hosting invitee side accepting the co-hosting invitation to the co-hosting invitee side pulling the first frame of audio and video of the peer is saved, to improve the co-hosting efficiency.

In S403, the co-hosting service server side forwards a co-hosting acceptance message to the co-hosting inviter side, in response to the co-hosting acceptance message for the co-hosting request received from a co-hosting invitee side.

In an embodiment of the present disclosure, after receiving co-hosting request, in response to the co-hosting acceptance operation triggered by the user, the co-hosting invitee side sends a co-hosting acceptance message to the co-hosting service server side. When receiving the co-hosting acceptance message, the co-hosting service server side forwards the co-hosting acceptance message to the co-hosting inviter side, to inform the co-hosting inviter side that the peer has accepted this co-hosting invitation.

In the embodiment of the present disclosure, co-hosting inviter side enters the virtual room in advance. Thus, after accepting the co-hosting invitation, the co-hosting invitee side no longer needs to wait for the co-hosting inviter side to enter the virtual room, which directly pulls the first frame of the audio and video streaming from the peer, so as to realize mutual co-hosting, which improves the co-hosting efficiency and the user experience of the co-hosting invitee side.

Since the version of the client affects the success rate of co-hosting, a lower version of the client may usually cause co-hosting failure. Therefore, in order to improve the success rate of co-hosting in the embodiment of the present disclosure, after receiving the co-hosting request from the co-hosting inviter side, the co-hosting service server side first determines whether the client versions of the co-hosting inviter side and the co-hosting invitee side corresponding to the co-hosting request meet a preset condition.

In an embodiment, before the co-hosting service server side replies to the co-hosting inviter side with a response message carrying the virtual room identifier, it may determine whether versions of the co-hosting inviter side and the co-hosting invitee side corresponding to the co-hosting request meet the preset condition. When it is determined that the versions of the co-hosting inviter side and the co-hosting invitee side corresponding to the co-hosting request meet the preset condition, the co-hosting service server side replies to the co-hosting inviter side with the response message carrying the virtual room identifier. In the case that one of the co-hosting inviter side and the co-hosting invitee side does not meet the preset condition, the current co-hosting is terminated, and a response message for rejecting co-hosting is sent to the co-hosting inviter side.

In addition, in order to improve co-hosting efficiency, in an embodiment of the present disclosure, the process of the co-hosting inviter side and co-hosting invitee side sending co-hosting notification messages to the co-hosting service server side, and the process of the co-hosting inviter side and co-hosting invitee side entering the co-hosting virtual room, are processed in parallel.

To this end, in an embodiment of the present disclosure, when the co-hosting service server side receives the co-hosting acceptance message for the co-hosting request from the co-hosting invitee side, the co-hosting service server side updates the co-hosting states of the co-hosting invitee side and the co-hosting inviter side to be in the connected states and starts timing. In a case that no co-hosting notification message is received from the co-hosting inviter side and the co-hosting invitee side within a preset time period, the co-hosting service server side updates the co-hosting states of the co-hosting inviter side and the co-hosting invitee side to be in the disconnected states.

On the basis of the above embodiments, a co-hosting method is further provided according to the present disclosure. Referring to FIG. 5, FIG. 5 illustrates a flowchart of a co-hosting method according to another embodiment of the present disclosure. The method includes steps S501 to S502.

In S501, after sending a co-hosting request to the co-hosting service server side, in response to receiving a response message for the co-hosting request, the co-hosting inviter side acquires the virtual room identifier from the response message and enters the virtual room corresponding to the virtual room identifier.

In S502, in response to a co-hosting acceptance message for the co-hosting request received from a co-hosting invitee side, an audio and video streaming is pushed to a real-time collaboration server side, where the audio and video streaming is provided to be pulled by the co-hosting invitee side.

In an embodiment of the present disclosure, when receiving a response message for the co-hosting request, the co-hosting inviter side can immediately enter the corresponding virtual room in advance according to the virtual room identifier in the response message.

Upon receiving the co-hosting acceptance message for the co-hosting request from co-hosting invitee side, the co-hosting inviter side directly pushes the audio and video streaming to the RTC server, rather than spend time entering the virtual room.

In an optional implementation, in the case that the co-hosting inviter side is in the online live state, upon receiving co-hosting acceptance message for co-hosting request from the co-hosting invitee side, the co-hosting inviter side first stops pushing online live streaming to the online live server side, and then starts pushing the audio and video streaming to the RTC server side to realize the switch from the online live state to the co-hosting state.

According to the embodiments of the present disclosure, the co-hosting method can reduce the consumption time from the co-hosting inviter side receiving the co-hosting acceptance message to the co-hosting inviter side pulling the first frame of the audio and video streaming from the peer, so as to improve the co-hosting efficiency and improve the co-hosting experience of the user.

In addition, since the co-hosting inviter side enters the virtual room in advance, the co-hosting invitee side does not need to wait for the peer to enter the virtual room after triggering the acceptance of the co-hosting invitation, which reduces the consumption time from the co-hosting invitee side triggering the acceptance of the co-hosting invitation to the co-hosting invitee side pulling the first frame of audio and video of the peer, so as to improve the co-hosting efficiency and the co-hosting experience of the co-hosting invitee side.

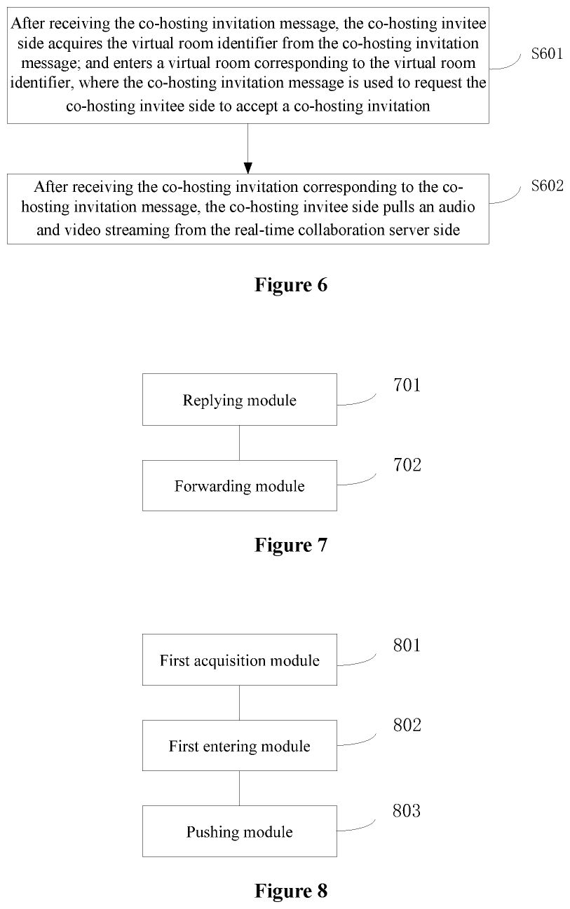

On the basis of the above embodiments, a co-hosting method is further provided according to the present disclosure. Referring to FIG. 6, FIG. 6 illustrates a flowchart of a co-hosting method according to another embodiment of the present disclosure. The method includes steps S601 to S602.

In S601, after receiving the co-hosting invitation message, the co-hosting invitee side acquires the virtual room identifier from the co-hosting invitation message; and enters a virtual room corresponding to the virtual room identifier, where the co-hosting invitation message is used to request the co-hosting invitee side to accept a co-hosting invitation.

In S602, after receiving the co-hosting invitation corresponding to the co-hosting invitation message, the co-hosting invitee side pulls an audio and video streaming from the real-time collaboration server side.

In an embodiment of the present disclosure, the co-hosting invitee side has already entered the virtual room in advance when accepting the co-hosting invitation of the current co-hosting. Thus, the co-hosting invitee side can directly push the audio and video streaming to the RTC server side to realize the co-hosting.

In an embodiment of the present disclosure, the co-hosting invitation message received by the co-hosting invitee side carries the virtual room identifier, so that the co-hosting invitee side can enter the virtual room in advance based on the virtual room identifier, without spending time on entering the virtual room at this moment. Thus, the consumption time from the co-hosting invitee side triggering the acceptance of the co-hosting invitation to the co-hosting invitee side pulling the first frame of audio and video of the peer is reduced, so as to improve the co-hosting efficiency and also improve the co-hosting experience of the co-hosting invitee side.

Based on the same inventive concept as the above method embodiments, a co-hosting apparatus is further provided according to the present disclosure. Referring to FIG. 7, FIG. 7 illustrates a schematic structural diagram of a co-hosting apparatus according to an embodiment of the present disclosure. The apparatus includes a replying module 701 and a forwarding module 702.

The replying module 701 is configured to reply to a co-hosting inviter side with a response message carrying a virtual room identifier, in response to a co-hosting request received from the co-hosting inviter side, where the response message is used to indicate a successful reception of the co-hosting request, and the virtual room identifier is used to enable the co-hosting inviter side to enter the virtual room.

The forwarding module 702 is configured to forward a co-hosting acceptance message to the co-hosting inviter side, in response to the co-hosting acceptance message for the co-hosting request received from a co-hosting invitee side.

In an optional implementation, the apparatus further includes: a sending module configured to send a co-hosting invitation message carrying the virtual room identifier to the co-hosting invitee side after receiving the co-hosting request, where the co-hosting invitation message is used to request the co-hosting invitee side to accept the co-hosting invitation, and the virtual room identifier is used to enable the co-hosting invitee side to enter the virtual room.

In an optional embodiment, the apparatus further includes: a determination module configured to determine whether versions of the co-hosting inviter side and the co-hosting invitee side corresponding to the co-hosting request meet the preset condition.

Correspondingly, the replying module is further configured to reply to the co-hosting inviter side with a response message carrying the virtual room identifier, in a case that it is determined that versions of both the co-hosting inviter side and the co-hosting invitee side corresponding to the co-hosting request meet the preset condition.

In an optional embodiment, the apparatus further includes: a first state update module and a second state update module.

The first state update module is configured to update co-hosting states of the co-hosting inviter side and the co-hosting invitee side to be in a connected state respectively, in response to the co-hosting acceptance message for the co-hosting request received from the co-hosting invitee side, and start timing.

The second state update module is configured to update co-hosting states of the co-hosting inviter side and the co-hosting invitee side to be in a disconnected state, in a case that no co-hosting notification message is received from the co-hosting inviter side and the co-hosting invitee side within a preset time period.

Based on the same inventive concept as the above method embodiments, a co-hosting apparatus is further provided according to the present disclosure. Referring to FIG. 8, FIG. 8 illustrates a schematic structural diagram of a co-hosting apparatus according to another embodiment of the present disclosure. The apparatus includes a first acquisition module 801, a first entering module 802 and a pushing module 803.

The first acquisition module 801 is configured to acquire a virtual room identifier from a response message, in response to a reception of the response message for a co-hosting request, after sending the co-hosting request to a co-hosting service server side.

The first entering module 802 is configured to enter a virtual room corresponding to the virtual room identifier.

The pushing module 803 is configured to push an audio and video streaming to a real-time collaboration server side in response to a co-hosting acceptance message for the co-hosting request received from a co-hosting invitee side.

In an optional embodiment, the apparatus further includes: a stopping pushing module configured to stop pushing online live streaming to an online live server side in response to the co-hosting acceptance message for the co-hosting request received from the co-hosting invitee side.

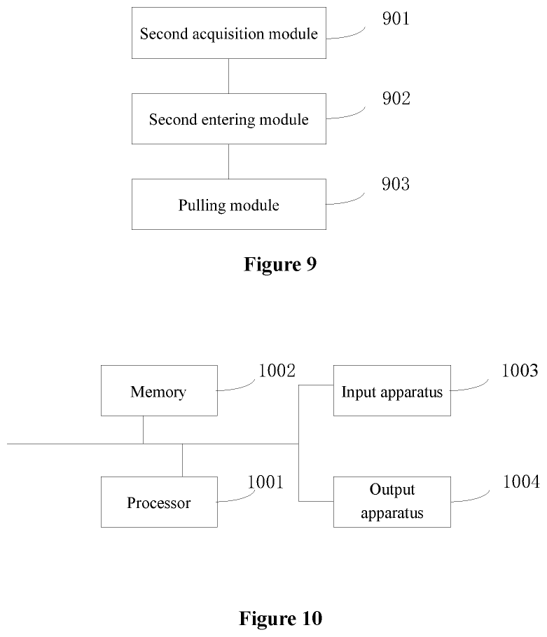

Based on the same inventive concept as the above method embodiments, a co-hosting apparatus is further provided according to the present disclosure. Referring to FIG. 9, FIG. 9 illustrates a schematic structural diagram of a co-hosting apparatus according to another embodiment of the present disclosure. The apparatus includes a second acquisition module 901, a second entering module 902 and a pulling module 903.

The second acquisition module 901 is configured to acquire a virtual room identifier from a co-hosting invitation message after receiving the co-hosting invitation message, where the co-hosting invitation message is used to request the co-hosting invitee side to accept a co-hosting invitation.

The second entering module 902 is configured to enter the virtual room corresponding to the virtual room identifier.

The pulling module 903 is configured to pull an audio and video streaming from a real-time collaboration server side, in response to a reception of the co-hosting invitation corresponding to the co-hosting invitation message.

In the co-hosting apparatus according to the present disclosure, since the co-hosting inviter side has already entered the virtual room in advance when the co-hosting invitee side receives the co-hosting acceptance operation, the co-hosting invitee side may directly pulls the first frame of the audio and video streaming from the peer, rather than waiting for the peer to enter the virtual room, which improves the co-hosting efficiency and improves the co-hosting experience of the user.

In addition to the above method and apparatus, a computer readable storage medium is further provided according to an embodiment of the present disclosure, where instructions are stored in the computer readable storage medium. The instructions, when executed by a terminal device, cause the terminal device to implement the co-hosting methods described in the embodiments of the present disclosure.

In addition, a co-hosting device is further provided according to an embodiment of the present disclosure. Referring to FIG. 10, the co-hosting device may include: a processor 1001, a memory 1002, an input apparatus 1003 and an output apparatus 1004.

The co-hosting device may include one or more processors 1001. One processor is taken as an example in FIG. 10. In some embodiments of the present disclosure, the processor 1001, the memory 1002, the input apparatus 1003 and the output apparatus 1004 may be connected through a bus or in other manner. In FIG. 10, a connection through the bus is taken as an example.

The memory 1002 may be configured to store a software program and module. The processor 1001 runs the software program and module stored in the memory 1002, to perform various functional applications and data processing of the picture processing device. The memory 1002 may mainly include a program memory area and a data memory area. An operating system, an application required by at least one function and the like are stored in the program memory area. In addition, the memory 1002 may include a high-speed random access memory, and may further include a non-volatile memory, such as at least one disk storage device, a flash device or other volatile solid-state storage device. The input apparatus 1003 may be configured to receive inputted number or character information, and generate a signal related to user settings and function control of the co-hosting device.

In the embodiment, the processor 1001 may load an executable file corresponding to the processes of one or more application programs into the memory 1002 in response to an instruction, and the processor 1001 runs the application programs stored in the memory 1002, thereby realizing various functions in the above co-hosting device.

It should be noted that the relationship terms “first”, “second” and the like herein are used for distinguishing an entity or operation from another entity or operation, but not intended to necessitate or imply an actual relationship or order between these entities or operations. Further, the terms “include”, “comprise” or any variant thereof are intended to encompass nonexclusive inclusion such that a process, method, article or device including a series of elements includes not only those elements but also other elements which have not been listed definitely or an element(s) inherent to the process, method, article or device. Unless expressively limited otherwise, a process, method, article or device limited by “comprising/including a(n) . . . ” does not exclude existence of another identical element in such process, method, article or device.

The above are only specific implementations of the present disclosure, such that those skilled in the art can understand or implement the present disclosure. It is obvious for those skilled in the art to make many modifications to these embodiments. The general principle defined herein may be applied to other embodiments without departing from the spirit or scope of the present disclosure. Therefore, the present disclosure is not limited to the embodiments illustrated herein, but should be defined by the broadest scope consistent with the principle and novel features disclosed herein.

1-5. (canceled)

6. A co-hosting method, comprising:
replying, by a co-hosting service server side, to a co-hosting inviter side with a response message carrying a virtual room identifier, in response to a co-hosting request received from the co-hosting inviter side, wherein the response message indicates a successful reception of the co-hosting request, and the virtual room identifier is used to enable the co-hosting inviter side to enter a virtual room; and
forwarding, by the co-hosting service server side, a co-hosting acceptance message to the co-hosting inviter side, in response to the co-hosting acceptance message for the co-hosting request received from a co-hosting invitee side.

7. The co-hosting method according to claim 6, wherein before the forwarding, by the co-hosting service server side, a co-hosting acceptance message to the co-hosting inviter side, in response to the co-hosting acceptance message for the co-hosting request received from a co-hosting invitee side, the method further comprises:
sending, by the co-hosting service server side, a co-hosting invitation message carrying the virtual room identifier to the co-hosting invitee side, after receiving the co-hosting request, wherein the co-hosting invitation message is used to request the co-hosting invitee side to accept the co-hosting invitation, and the virtual room identifier is used to enable the co-hosting invitee side to enter the virtual room.

8. The co-hosting method according to claim 6, before the replying to a co-hosting inviter side with a response message carrying a virtual room identifier, the method further comprises:
determining, by the co-hosting service server side, whether versions of the co-hosting inviter side and the co-hosting invitee side corresponding to the co-hosting request meet a preset condition; and
the replying to a co-hosting inviter side with a response message carrying a virtual room identifier comprises:
replying to the co-hosting inviter side with the response message carrying the virtual room identifier, in response to a determination that the versions of the co-hosting inviter side and the co-hosting invitee side corresponding to the co-hosting request meet the preset condition.

9. The co-hosting method according to claim 6, further comprising:
updating, by the co-hosting service server side, co-hosting states of the co-hosting inviter side and the co-hosting invitee side to be in a connected state respectively, in response to the co-hosting acceptance message for the co-hosting request received from the co-hosting invitee side, and starting timing; and
updating the co-hosting state of the co-hosting inviter side and the co-hosting state of the co-hosting invitee side to be in a disconnected state respectively, in a case that no co-hosting notification message is received from the co-hosting inviter side and the co-hosting invitee side within a preset time period.

10. A co-hosting method, comprising:
acquiring, by a co-hosting inviter side, a virtual room identifier from a response message, in response to a reception of the response message for a co-hosting request, after sending the co-hosting request to a co-hosting service server side;
entering a virtual room corresponding to the virtual room identifier; and
pushing an audio and video streaming to a real-time collaboration server side, in response to a co-hosting acceptance message for the co-hosting request received from a co-hosting invitee side, wherein the audio and video streaming is provided to be pulled by the co-hosting invitee side.

11. The co-hosting method according to claim 10, wherein the co-hosting inviter side is in an online live state; and
before pushing the audio and video streaming to the real-time collaboration server side, the method further comprises:
stopping pushing online live streaming to an online live server side, in response to the co-hosting acceptance message for the co-hosting request received from the co-hosting invitee side.

12. A co-hosting method, comprising:
acquiring, by a co-hosting invitee side, a virtual room identifier from a co-hosting invitation message after receiving the co-hosting invitation message, and entering into a virtual room corresponding to the virtual room identifier, wherein the co-hosting invitation message is used to request the co-hosting invitee side to accept a co-hosting invitation; and
pulling, by the co-hosting invitee side, an audio and video streaming from a real-time collaboration server side, in response to a reception of the co-hosting invitation corresponding to the co-hosting invitation message.

13-15. (canceled)

16. A non-transitory computer readable storage medium storing instructions, wherein the instructions when executed by a computer device, cause the computer device to:
reply to a co-hosting inviter side with a response message carrying a virtual room identity identifier, in response to a co-hosting request received from the co-hosting inviter side, wherein the response message indicates a successful reception of the co-hosting request, and the virtual room identity identifier is used to enable the co-hosting inviter side to enter a virtual room; and forward a co-hosting acceptance message to the co-hosting inviter side, in response to the co-hosting acceptance message for the co-hosting request received from a co-hosting invitee side; or
acquire a virtual room identifier from a response message, in response to a reception of the response message for a co-hosting request, after the co-hosting request is sent to a co-hosting service server side; enter a virtual room corresponding to the virtual room identifier; and push an audio and video streaming to a real-time collaboration server side, in response to a co-hosting acceptance message for the co-hosting request received from a co-hosting invitee side, wherein the audio and video streaming is provided to be pulled by the co-hosting invitee side; or
acquire a virtual room identifier from a co-hosting invitation message after the co-hosting invitation message is received, and enter into a virtual room corresponding to the virtual room identifier, wherein the co-hosting invitation message is used to request a co-hosting invitee side to accept a co-hosting invitation; and pull an audio and video streaming from a real-time collaboration server side, in response to a reception of the co-hosting invitation corresponding to the co-hosting invitation message.

17. A device, comprising:
a memory;
a processor; and
a computer program stored in the memory,
wherein the computer program, when executed by the processor, causes the processor to:
reply to a co-hosting inviter side with a response message carrying a virtual room identity identifier, in response to a co-hosting request received from the co-hosting inviter side, wherein the response message indicates a successful reception of the co-hosting request, and the virtual room identity identifier is used to enable the co-hosting inviter side to enter a virtual room; and forward a co-hosting acceptance message to the co-hosting inviter side, in response to the co-hosting acceptance message for the co-hosting request received from a co-hosting invitee side; or
acquire a virtual room identifier from a response message, in response to a reception of the response message for a co-hosting request, after the co-hosting request is sent to a co-hosting service server side; enter a virtual room corresponding to the virtual room identifier; and push an audio and video streaming to a real-time collaboration server side, in response to a co-hosting acceptance message for the co-hosting request received from a co-hosting invitee side, wherein the audio and video streaming is provided to be pulled by the co-hosting invitee side; or
acquire a virtual room identifier from a co-hosting invitation message after the co-hosting invitation message is received, and enter into a virtual room corresponding to the virtual room identifier, wherein the co-hosting invitation message is used to request a co-hosting invitee side to accept a co-hosting invitation; and pull an audio and video streaming from a real-time collaboration server side, in response to a reception of the co-hosting invitation corresponding to the co-hosting invitation message.

18. The device according to claim 17, wherein before the co-hosting acceptance message is forwarded to the co-hosting inviter side in response to the co-hosting acceptance message for the co-hosting request received from a co-hosting invitee side, the computer program, when executed by the processor, causes the processor to:
send a co-hosting invitation message carrying the virtual room identifier to the co-hosting invitee side, after receiving the co-hosting request, wherein the co-hosting invitation message is used to request the co-hosting invitee side to accept the co-hosting invitation, and the virtual room identifier is used to enable the co-hosting invitee side to enter the virtual room.

19. The device according to claim 17, wherein before the response message carrying the virtual room identifier is replied to the co-hosting inviter side, the computer program, when executed by the processor, causes the processor to:
determine whether versions of the co-hosting inviter side and the co-hosting invitee side corresponding to the co-hosting request meet a preset condition; and
wherein the response message carrying a virtual room identity identifier is replied to the co-hosting inviter side by:
replying to the co-hosting inviter side with the response message carrying the virtual room identifier, in response to a determination that the versions of the co-hosting inviter side and the co-hosting invitee side corresponding to the co-hosting request meet the preset condition.

20. The device according to claim 17, wherein the computer program, when executed by the processor, causes the processor to:
update co-hosting states of the co-hosting inviter side and the co-hosting invitee side to be in a connected state respectively, in response to the co-hosting acceptance message for the co-hosting request received from the co-hosting invitee side, and start timing; and
update the co-hosting state of the co-hosting inviter side and the co-hosting state of the co-hosting invitee side to be in a disconnected state respectively, in a case that no co-hosting notification message is received from the co-hosting inviter side and the co-hosting invitee side within a preset time period.

21. The device according to claim 17, wherein the co-hosting inviter side is in an online live state; and
before the audio and video stream is pushed to the real-time collaboration server side, the computer program, when executed by the processor, causes the processor to:
stop pushing online live streaming to an online live server side, in response to the co-hosting acceptance message for the co-hosting request received from the co-hosting invitee side.
